(19) United States
(12) Patent Application Publication
(10) Pub. No.: US 2014/0295849 A1
(43) Pub. Date: Oct. 2, 2014

(54) HANDOVER OF USER EQUIPMENT WITH NON-GBR BEARERS

(71) Applicant: Alexander Sirotkin, Petach Tikva (IL)

(72) Inventor: Alexander Sirotkin, Petach Tikva (IL)

(21) Appl. No.: 14/141,250

(22) Filed: Dec. 26, 2013

Related U.S. Application Data
(60) Provisional application No. 61/806,821, filed on Mar. 29, 2013.

(51) Int. Cl. H04W 36/08; H04W 36/30

(52) U.S. Cl. CPC H04W 36/08; H04W 36/30
USPC 455/437

(57) ABSTRACT

Embodiments of the present disclosure include systems and methods for handover of user equipment (UE) having non-guaranteed bit rate (non-GBR) bearers. In some embodiments, an access node (AN) may include UE logic to identify a UE having at least one non-GBR bearer, target AN logic to identify a target AN to take over service of the UE from the AN, and handover source logic, coupled with the UE logic and the target AN logic, to provide handover request information to the target AN. The handover request information may include a value representative of realized throughput of the at least one non-GBR bearer. Other embodiments may be described and/or claimed.

### CROSS-REFERENCE TO RELATED APPLICATION

This application claims priority to U.S. Provisional Application No. 61/806,821, filed Mar. 29, 2013 and entitled “ADVANCED WIRELESS COMMUNICATION SYSTEMS AND TECHNIQUES,” which is hereby incorporated by reference herein in its entirety.

### FIELD

Embodiments of the present disclosure generally relates to the field of wireless communication, and more particularly, to handover of user equipment with non-guaranteed bit rate bearers.

### BACKGROUND

Some services used by users of conventional wireless communication devices, such as real-time videoconferencing, may be guaranteed minimum data rates to preserve the quality of the user's experience during use of the service. Other services, such as watching streaming movies, may not be guaranteed such minimum data rates. When devices running these other services are handed between two different wireless communication cells, the user may experience an abrupt and substantial change in the quality of wireless communication performance. Substantial drops in performance may negatively impact the user's experience with the device.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example wireless communication network, in accordance with various embodiments.

FIG. 2 is a block diagram of an illustrative source access node (AN) configured to provide handover request information indicative of a realized throughput of a non-guaranteed bit rate (non-GBR) bearer of a user equipment (UE), in accordance with various embodiments.

FIG. 3 is a block diagram of an illustrative target AN configured to receive the handover request information provided by the source AN of FIG. 2, in accordance with various embodiments.

FIG. 4 is a flow diagram of a process for handing over a UE from a source AN to a target AN, in accordance with various embodiments.

FIG. 5 is a flow diagram of a process for taking over service of a UE by a target AN from a source AN, in accordance with various embodiments.

FIG. 6 is a block diagram of an example computing device that may be used to practice various embodiments described herein.

### DETAILED DESCRIPTION

Embodiments of the present disclosure include systems and methods for handover of user equipment (UE) having non-guaranteed bit rate (non-GBR) bearers. In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the terms “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable hardware components that provide the described functionality.

The embodiments described herein may be used in a variety of applications including transmitters and receivers of a mobile wireless radio system. Radio systems specifically included within the scope of the embodiments include, but are not limited to, network interface cards (NICs), network adaptors, base stations, access points (APs), relay nodes, Node Bs, gateways, bridges, hubs and satellite radiotelephones. Further, the radio systems within the scope of embodiments may include satellite systems, personal communication systems (PCSs), two-way radio systems, global positioning systems (GPS), two-way pagers, personal computers (PCs) and related peripherals, personal digital assistants (PDAs), and personal computing, among others.

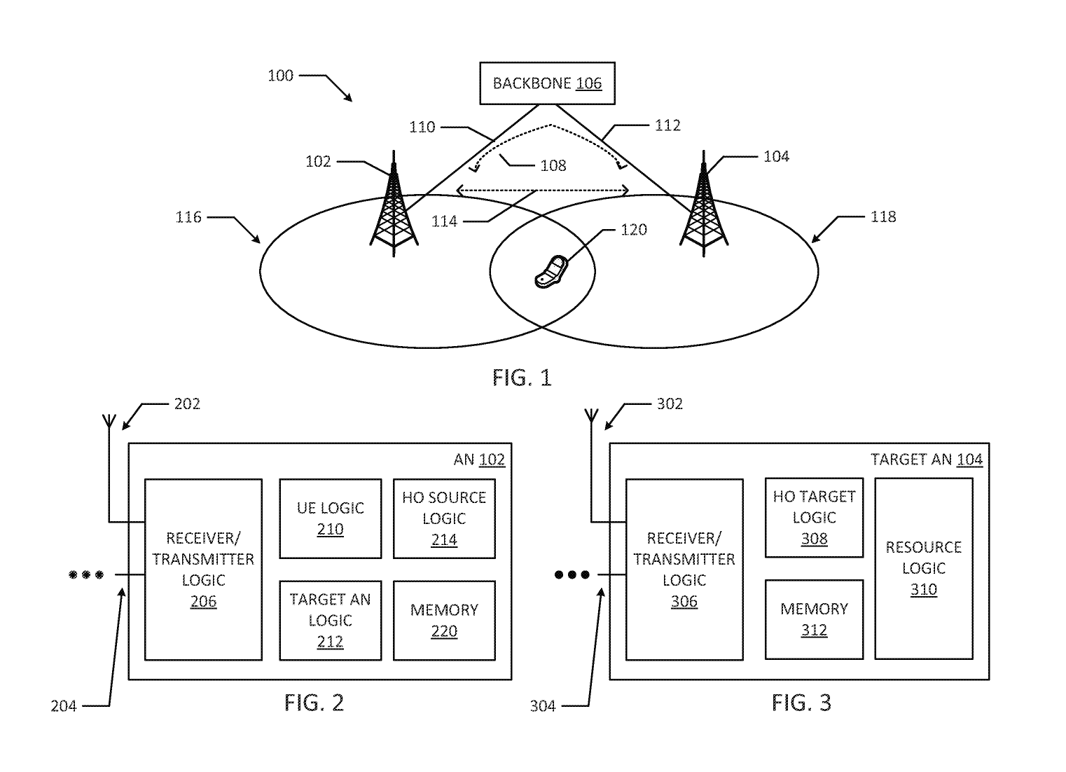

Referring now to FIG. 1, an example wireless communication environment 100, in accordance with various embodiments, is illustrated. The wireless communication environment 100 may be configured as one or more wireless communication networks, such as a wireless personal area network (WPAN), a wireless local area network (WLAN), and a wireless metropolitan area network (WMAN). As discussed below, the wireless communication environment 100 may be configured for improved handover of UEs having non-GBR bearers.

The wireless communication environment 100 may include one or more UEs. A single UE 120 is illustrated in FIG. 1, although the wireless communication environment 100 may support many UEs. The UE 120 may include a wireless electronic device such as a desktop computer, a laptop computer, a handheld computer, a tablet computer, a cellular telephone, a pager, an audio and/or video player (e.g., an MP3 player or a DVD player), a gaming device, a video camera, a digital camera, a navigation device (e.g., a GPS device), a wireless peripheral (e.g., a printer, a scanner, a headset, a keyboard, a mouse, etc.), a medical device (e.g., a heart rate monitor, a blood pressure monitor, etc.), and/or other suitable fixed, portable, or mobile electronic devices.

The UE 120 may be configured to communicate via radio links with one or more access nodes (ANs), generally shown as 102 and 104. Each AN may serve zero, one or more UEs in a cell associated with the AN. For example, as illustrated in FIG. 1, the AN 102 may serve the UE 120 in a cell 116. In some embodiments, the ANs 102 and 104 may include or be included in evolved node Bs (eNBs), remote radio heads (RRHs), or other wireless communication components. In some embodiments, the ANs 102 and 104 may be eNBs deployed in a heterogeneous network. In such embodiments, the ANs 102 and 104 may be referred to as, for example, femto-, pico-, or macro-eNBs and may be respectively associated with femtocells, picocells, or macrocells.

Wireless communication may include a variety of modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation, orthogonal frequency-division multiplexing (OFDM) modulation, multi-carrier modulation (MDM), and/or other suitable modulation techniques to communicate via wireless links. The ANs 102 and 104 may be connected to a backbone network 106, through which authentication and inter-AN communication may occur. Various components may be included in the backbone network 106. For example, in some embodiments, the backbone network 106 may include a Mobility Management Entity (MME), which may manage control plane functions related to UE and session management. The backbone network 106 may include a serving gateway (S-GW), which may serve as a point through which packets are routed as UEs move within the communication environment 100.

In particular, the AN 102 may communicate with the backbone network 106 via the communication link 110, and the AN 104 may communicate with the backbone network 106 via the communication link 112. In some embodiments, the communication link 110 and/or the communication link 112 may include wired communication links (and may include electrically conductive cabling and/or optical cabling, for example) and/or wireless communication links. In some embodiments, the communication link 110 and/or the communication link 112 may be S1 communication links. The communication pathway between the AN 102 and the AN 104 via the communication link 110, the backbone network 106, and the communication link 112 may be referred to as a backhaul link 108. In some embodiments, the AN 102 may communicate directly with the AN 104 via the communication link 114. The communication link 114 may include wired communication links and/or wireless communication links. In some embodiments the communication link 114 may be an X2 communication link (which may be a wired communication link). Although the cells 116 and 118 are depicted as overlapping in a limited area, the cells 116 and 118 may have any of a number of relationships. For example, in some embodiments, the cell 116 may be a femtocell and the cell 118 may be a macrocell substantially covering the cell 116.

The UE 120 may be configured to communicate using a multiple-input and multiple-output (MIMO) communication scheme. The ANs 102 and 104 may include one or more antennas, one or more radio modules to modulate and/or demodulate signals transmitted or received on an air interface, and one or more digital modules to process signals transmitted and received on the air interface. Example components of the AN 102 are discussed below. One or more antennas of the UE 120 may be used to concurrently utilize radio resources of multiple respective component carriers (e.g., which may correspond with antennas of ANs 102 and 104) of the wireless communication environment 100.

Embodiments of the systems and methods described herein may be implemented in broadband wireless access networks including networks operating in conformance with one or more protocols specified by the Third Generation Partnership Project (3GPP) and its derivatives, the Worldwide Interoperability for Microwave Access (WiMAX) Forum, the IEEE 802.16 standards (e.g., IEEE 802.16-2005 Amendment), the Long Term Evolution (LTE) project along with any amendments, updates, and/or revisions (e.g., advanced LTE project, ultra mobile broadband (UMB) project (also referred to as 3GPP2), etc.). Many of the examples described herein may refer to wireless communication networks that conform with 3GPP for ease of discussion; however, the subject matter of the present disclosure is not limited in this regard and the described embodiments may apply to other wireless communication networks that may benefit from the systems and techniques described herein, such as specifications and/or standards developed by other special interest groups and/or standard development organizations (e.g., Wireless Fidelity (Wi-Fi) Alliance, WiMAX Forum, Infrared Data Association (IrDA), etc.).

In some embodiments, the AN 102 may attempt to transition service of the UE 120 from the AN 102 to the cell 118 of the AN 104. The process of transferring service of a UE from one AN to another may be referred to herein as “handover.” With reference to the handover of the UE 120, the AN 102 may be referred to as the “source” AN and the cell 116 may be referred to as the “source” cell, while the AN 104 may be referred to as the “target” AN and the cell 118 may be referred to as the “target” cell.

Handover of the UE 120 from a femtocell to a macrocell under certain conditions may be advantageous for energy saving purposes, as discussed below.

In some embodiments, the target AN 104 may use a different radio access technology (RAT) than the source AN 102. Examples of various RATs include Universal Terrestrial Access (UTRA), Evolved Universal Terrestrial Access (E-UTRA), IEEE02.20, General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), GSM EDGE Radio Access (GERA), Code Division Multiple Access (CDMA), Time Division Multiple Access (TDMA), Digital Enhanced Cordless Telecommunications (DECT), Bluetooth, derivatives thereof, as well as any other wireless protocols that are designated as 3G, 4G, 5G, and beyond. For example, the source AN 102 may use E-UTRA while the target AN 104 may use GERA. In some embodiments, the target AN 104 may use a same RAT as the source AN 102.

In some embodiments, handover of the UE 120 may be managed by the source AN 102, the target AN 104, and the backbone network 106, but may be assisted by information provided by the UE 120. For example, the UE 120 may send measurement report messages to the source AN 102 (periodically and/or based on a reporting event) indicating the signal strength or quality of the source cell (e.g., a reference signal received power (RSRP) and/or a reference signal received quality (RSRQ)), neighboring cells detected by the UE 120 (e.g., the cell 118 and any other nearby cells, not shown) and/or the signal strength or quality of the neighboring cells. The source AN 102 may use this information to evaluate candidate neighboring cells for handover of the UE 120, as discussed below.

Referring now to FIG. 2, example components of the source AN 102 are illustrated. The components of the source AN 102, discussed in detail below, may be included in any one or more ANs included in a wireless communication network (e.g., the AN 104 of the wireless communication environment 100). In some embodiments, the source AN 102 may be an eNB, or included in an eNB.

The source AN 102 may include receiver/transmitter logic 206. The receiver/transmitter logic 206 may be coupled with an antenna 202 and/or a wired communication interface 204, and may be configured to receive and/or transmit wired and/or wireless signals to other devices, such as any of the devices discussed above with reference to FIG. 1. The antenna 202 may include one or more directional or omni-directional antennas such as dipole antennas, monopole antennas, patch antennas, loop antennas, microstrip antennas, and/or other types of antennas suitable for reception and/or transmission of radio frequency (RF) or other wireless communication signals. Although FIG. 2 depicts a single antenna, the source AN 102 may include additional antennas to receive and/or transmit wireless signals. The wired communication interface 204 may be configured for communication over an electrically conductive carrier and/or an optical carrier, for example. In some embodiments, the receiver/transmitter logic 206 may be configured to receive data from and/or transmit data to the UE 120. In some embodiments, the receiver/transmitter logic 206 may be configured to receive data from and/or transmit data to the AN 104 (e.g., via the communication link 114 and/or via the backhaul link 108). In some embodiments, the receiver/transmitter logic 206 may be configured to receive data from and/or transmit data to the backbone network 106 (e.g., via the communication link 110).

The source AN 102 may include UE logic 210. The UE logic 210 may be coupled to the receiver/transmitter logic 206, and may be configured to identify one or more UEs served by the AN 102 in the cell 116. For ease of illustration, the UE logic 210 may be discussed herein as identifying the UE 120 as a UE served by the source AN 102. In some embodiments, the UE logic 210 may identify the UE 120 by storing an identifier of the UE 120 in a memory 220. The identifier of the UE 120 may be obtained from information provided by the UE 120 or via other communication pathways.

In some embodiments, the UE logic 210 may be configured to identify one or more bearers of the UE 120. As used herein, a “bearer” may refer to a data pathway between a component of the backbone network 106 (e.g. a gateway) and a UE that is characterized by a type of service supported by the data pathway and/or quality of service (QoS) attributes of the data pathway. Examples of QoS attributes may include maximum delay, residual error rate, guaranteed bit rate, and maximum bit rate. In some embodiments, the bearers of the UE 120 may be Evolved Universal Terrestrial Radio Access Network Radio Access Bearers (E-RABs), which may extend between the UE 120 and an S-GW included in the backbone network 106.

The bearers of the UE 120 may include bearers of any of a number of different types. For example, the bearers may include one or more GBR bearers. A GBR bearer is associated with a minimum bit rate that is to be maintained by an AN serving the GBR bearer (e.g., the source AN 102 serving a GBR bearer of the UE 120). Examples of traffic for which GBR bearers may be used include voice over IP (VoIP), live streaming video, real-time gaming and other applications designated as bit rate critical or for which a user has paid for or otherwise requested a minimum GBR, in various embodiments. An application may be designated as a GBR bearer when an operator would prefer to block a request from the application rather than risk poor performance of an admitted request.

In some embodiments, the bearers of the UE 120 may include one or more non-GBR bearers. A non-GBR bearer may be a bearer that is not entitled to minimum QoS requirements (such as a minimum GBR). When ample resources are available, a GBR bearer may utilize the desired amount. However, when resources are limited (e.g., under times of network congestion), a non-GBR bearer may receive few to no resources, and performance of the non-GBR bearer service may suffer. Examples of traffic for which non-GBR bearers may be used include web browsing, email, chat, and non-real-time video, in various embodiments.

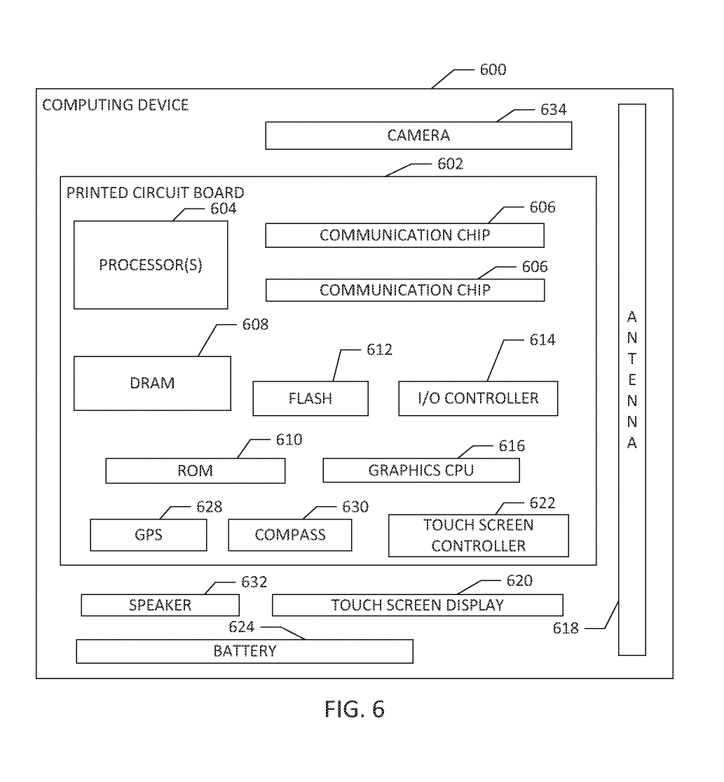

The AN 102 may include target AN logic 212. The target AN logic 212 may be coupled to the UE logic 210, and may be configured to identify a target AN to take over service of one or more UEs served by the AN 102 (e.g., service of one or more bearers of the UE 120). For ease of illustration, the target AN logic 212 may be discussed herein as identifying AN 104 as the target AN to take over service of the UE 120. In some embodiments, the target AN logic 212 may identify the target AN 104 by storing an identifier of the target AN 104 in the memory 220. The memory 220 may include any suitable memory device(s) and supporting circuitry, such as the memory devices discussed below with reference to FIG. 6, and may store any suitable information used in handover operations by the AN 102. The identifier of the target AN 104 may be obtained from information provided by the UE 120 or via other communication pathways.

The AN 102 may include handover source logic 214. The handover source logic 214 may be coupled with the UE logic 210 in the target AN logic 212, and may be configured to perform any suitable operations for initiating, performing, and completing a handover of a UE to a target AN. In particular, the handover source logic 214 may provide handover request information to a target AN identified by the target AN logic 212 for handover of the UE identified by the UE logic 210. For ease of illustration, the handover source logic 214 may be discussed herein as providing handover request information to the AN 104 as the target AN to take over service of the UE 120. In some embodiments, the target AN logic 212 and handover source logic 214 may be configured to identify and evaluate a candidate neighboring cell for handover of the UE 120. The identification and/or evaluation may be based on information provided by the UE 120.

In some embodiments, the handover request information provided by the handover source logic 214 may include a value representative of a realized throughput of at least one non-GBR bearer of the UE 120. As used herein, a “throughput” may be a quantity representative of a number of symbols transmitted per unit time. A “realized throughput” may be a quantity representative of a throughput previously and/or currently experienced by a device. A realized throughput may be based on one or more past or current throughputs. For example, a realized throughput may be an average throughput over the last hour of operation of a device, as discussed below. Although the singular term “value” may be used with reference to a realized throughput, a value may include one or more values unless a particular quantity of values is indicated. In some embodiments, the value representative of the realized throughput may be representative of a realized uplink throughput. In some embodiments, the value representative of the realized throughput may be representative of a realized downlink throughput. In some embodiments, the value representative of the realized throughput may be representative of a combination of uplink and downlink throughputs (e.g., a total uplink and downlink throughput, or an average throughput). In some embodiments, the value representative of the realized throughput may be representative of an average throughput (e.g., uplink, downlink, or combination) over a time window. In some embodiments, the value representative of the realized throughput may be representative of a maximum or a minimum throughput (e.g., uplink, downlink, or combination) over a time window. The duration of any of the time windows discussed herein may be fixed or dynamic, and may be signaled by the UE 120 or the source AN 102.

In some embodiments, the UE 120 may include multiple non-GBR bearers. In some such embodiments, the value representative of the realized throughput includes multiple values, each value representative of a realized throughput of a corresponding non-GBR bearer. In some embodiments in which the UE 120 includes multiple non-GBR bearers, the value representative of the realized throughput includes fewer values than the total number of non-GBR bearers. For example, the value representative of the realized throughput may include a single value representative of realized throughputs of multiple non-GBR bearers. Various examples of such embodiments are discussed below with reference to Tables 1 through 7.

In some embodiments, the handover request information from the handover source logic 214 may be designated for provision to the target AN 104 via the backhaul link 108.

The handover source logic 214 may provide the handover request information for transmission to the target AN 104 by the receiver/transmitter logic 206. The value representative of the realized throughput of the non-GBR bearers may be provided to the target AN 104 in any of a number of forms. For example, in some embodiments, the value may be provided to the target AN 104 in a handover request message. A handover request message may be sent by a source AN to a target AN to request the preparation of resources for a handover. The handover request message, or other messages transmitted from the source AN 102 to the target AN 104, may include any of a number of different types of information, in addition to the value representative of the realized throughput of non-GBR bearers. For example, a message may include a “cause” field, including a reason for the handover request (such as that the handover is desirable for radio reasons). In some embodiments, the handover source logic 214 may include an indicator that the handover is intended for energy saving purposes in the handover request information. Various embodiments of the systems and techniques disclosed herein in the energy-saving contacts are discussed below.

Tables 1 through 7 below describe various embodiments of handover request information that may be communicated between the source AN 102 and the target AN 104. Some of the embodiments described below may be directed to communications transmitted over a S1 communication pathway in a 3GPP LTE network (which may include, for example, the communication links 110 and 112); these embodiments may be applied in a straightforward manner to communications transmitted over an X2 communication pathway (which may include, for example, the communication link 114) or any other pathway in any desired network.

An example handover request message format is shown in Table 1. The column “IE/Group Name” may indicate information elements or groups of information elements that may be included in a handover request message. The remaining columns may provide descriptions of these information elements or groups of information elements that may be included in the handover request message. For example, the column “Presence” may indicate whether the presence of the corresponding information element or group of information elements is mandatory (M) or optional (O) in the handover request message. The designations in the “Presence” column are illustrative, and may vary for different embodiments. The column “Range” may indicate the range of possible values of the corresponding information element or group of information elements. The column “IE type and reference” may indicate where further information about the corresponding information element or group of information element may be found within the Technical Specifications published by 3GPP. Alternate or additional information about any one or more of the information elements or groups of information elements listed in Table 1 may be discussed herein. The column “Semantics description” may provide a brief description of the information element or group of information elements. The column “Criticality” may indicate whether or not the corresponding information element or group of information elements has criticality information associated with it. The column “Assigned Criticality” may indicate how the target AN 104 (receiving the handover request message) is to respond when the corresponding information element or group of information elements is not understood or missing.

TABLE 1
Example handover request message format.

| | | | | Semantics | | Assigned |
|---|---|---|---|---|---|---|
| IE/Group Name | Presence | Range | IE type and reference | description | Criticality | Criticality |
| Message Type | M | | 9.2.13 | | YES | reject |
| Old eNB UE X2AP | M | | eNB UE X2AP ID | Allocated at the | YES | reject |
| ID | | | 9.2.24 | source eNB | | |
| Cause | M | | 9.2.6 | | YES | ignore |
| Target Cell ID | M | | ECGI | | YES | reject |
| | | | 9.2.14 | | | |
| GUMMEI | M | | 9.2.16 | | YES | reject |
| UE Context | | 1 | | | YES | reject |
| Information | | | | | | |
| >MME UE S1AP | M | | INTEGER (0 . . . 2³² − 1) | MME UE S1AP ID | — | — |
| ID | | | | allocated at the | | |
| | | | | MME | | |
| >UE Security | M | | 9.2.29 | | — | — |
| Capabilities | | | | | | |
| >AS Security | M | | 9.2.30 | | — | — |
| Information | | | | | | |
| >UE Aggregate | M | | 9.2.12 | | — | — |
| Maximum Bit | | | | | | |
| Rate | | | | | | |
| >Subscriber | O | | 9.2.25 | | — | — |
| Profile ID for | | | | | | |
| RAT/Frequency | | | | | | |
| priority | | | | | | |
| >E-RABs To Be | | 1 | | | — | — |
| Setup List | | | | | | |
| >>E-RABs To | | 1 . . . | | | EACH | ignore |
| Be Setup | | <maxnoof | | | | |
| Item | | Bearers> | | | | |
| >>>E-RAB | M | | 9.2.23 | | — | — |
| ID | | | | | | |
| >>>E-RAB | M | | 9.2.9 | Includes | — | — |
| Level QoS | | | | necessary QoS | | |
| Parameters | | | | parameters | | |
| >>>DL | O | | 9.2.5 | | — | — |
| Forwarding | | | | | | |
| >>>UL GTP | M | | GTP Tunnel | SGW endpoint of | — | — |
| Tunnel | | | Endpoint 9.2.1 | the S1 transport | | |
| Endpoint | | | | bearer. For | | |
| | | | | delivery of UL | | |
| | | | | PDUs. | | |
| >RRC Context | M | | OCTET STRING | Includes the RRC | — | — |
| | | | | Handover | | |
| | | | | Preparation | | |
| | | | | Information | | |
| | | | | message as | | |
| | | | | defined in | | |
| | | | | subclause 10.2.2 | | |
| | | | | of TS 36.331 [9] | | |
| >Handover | O | | 9.2.3 | | — | — |
| Restriction List | | | | | | |
| >Location | O | | 9.2.21 | Includes the | — | — |
| Reporting | | | | necessary | | |
| Information | | | | parameters for | | |
| | | | | location | | |
| | | | | reporting | | |
| >Management | O | | 9.2.59 | | YES | ignore |
| Based MDT | | | | | | |
| Allowed | | | | | | |
| >Management | O | | MDT PLMN List | | YES | ignore |
| Based MDT | | | 9.2.64 | | | |
| PLMN List | | | | | | |
| UE History | M | | 9.2.38 | Same definition | YES | ignore |
| Information | | | | as in TS 36.413 | | |
| | | | | [4] | | |
| Trace Activation | O | | 9.2.2 | | YES | ignore |
| SRVCC Operation | O | | 9.2.33 | | YES | ignore |
| Possible | | | | | | |
| CSG Membership | O | | 9.2.52 | | YES | reject |
| Status | | | | | | |
| Mobility | O | | BIT STRING (SIZE (32)) | Information | YES | ignore |
| Information | | | | related to the | | |
| | | | | handover; the | | |
| | | | | source eNB | | |
| | | | | provides it in | | |
| | | | | order to enable | | |
| | | | | later analysis of | | |
| | | | | the conditions | | |
| | | | | that led to a | | |
| | | | | wrong HO. | | |

In some embodiments, the value representative of the realized throughput of the non-GBR bearers may be included in an “E-RAB Level QoS Parameters” information element, which may specify QoS parameters for one or more bearers of the UE 120. The E-RAB Level QoS Parameters information element may itself be included in a handover request message, as illustrated in the example handover request message format of Table 1. In particular, Table 1 indicates that an E-RAB Level QoS Parameters information element may be included in the handover request message for each bearer listed in the “E-RABs To Be Setup Item” (which may identify each of the bearers of the UE 120). Thus, information about each bearer may be provided separately through different E-RAB Level QoS Parameters information elements.

An example E-RAB Level QoS Parameters information element is illustrated in Table 2. In the E-RAB Level QoS Parameters information element of Table 2, and the information element “non-GBR QoS Information” is included, and presence and semantics information are shown. The non-GBR QoS Information information element may be included when the UE 120 has one or more non-GBR bearers, and may specify QoS information regarding the one or more non-GBR bearers (such as realized throughput information).

TABLE 2
Example E-RAB Level QoS Parameter Information element.

| IE/Group Name | | | | |
|---|---|---|---|---|
| E-RAB | | | IE type | |
| Level QoS | | | and | Semantics |
| Parameters | Presence | Range | reference | description |
| >QCI | M | | INTEGER | QoS Class |
| | | | (0 . . . | Identifier |
| | | | 255) | defined in TS |
| | | | | 23.401 [11]. |
| | | | | Coding specified |
| | | | | in TS 23.203 [13]. |
| >Allocation | M | | 9.2.1.60 | |
| and Retention | | | | |
| Priority | | | | |
| >GBR QoS | 0 | | 9.2.1.18 | This IE applies |
| Information | | | | to GBR bearers |
| | | | | only and shall be |
| | | | | ignored otherwise. |
| >non-GBR QoS | 0 | | | This IE applies to |
| Information | | | | non-GBR bearers |
| | | | | only and shall be |
| | | | | ignored otherwise. |

Table 3 provides an illustrative non-GBR QoS Information information element, such as may be used with the E-RAB Level QoS Parameters information element of Table 2. The non-GBR QoS Information information element of Table 3 may include separate values for average downlink throughput and average uplink throughput for a particular non-GBR bearer (averaged over a time window). The particular throughput values of Table 3 are simply illustrative, and any value representative of realized throughput or other realized or desired performance characteristics of non-GBR bearer services may be used. Table 4 provides an illustrative structure for the non-GBR QoS Information information element of Table 3.

TABLE 3
Example non-GBR QoS Information Information element.

| | | | IE type and | Semantics |
|---|---|---|---|---|
| IE/Group Name | Presence | Range | reference | description |
| E-RAB Average | M | | Bit Rate | Desc.: This IE |
| Throughput | | | 9.2.1.19 | indicates the |
| Downlink | | | | average downlink |
| | | | | E-RAB Bit Rate |
| | | | | for this bearer. |
| E-RAB Average | M | | Bit Rate | Desc.: This IE |
| Throughput | | | 9.2.1.19 | indicates the |
| Uplink | | | | average uplink |
| | | | | E-RAB Bit for |
| | | | | this bearer. |

TABLE 4
Example structure for a non-GBR QoS
Information information element.

non-GBR-QosInformation ::= SEQUENCE {

| | |
|---|---|
| e-RAB-AverageBitrateDL | BitRate, |
| e-RAB-AverageBitrateUL | BitRate, |

| | |
|---|---|
| iE-Extensions | ProtocolExtensionContainer { { |
| | non-GBR-QosInformation-ExtIEs} } |
| | OPTIONAL, |

...

}
non-GBR-QosInformation-ExtIEs S1AP-PROTOCOL-EXTENSION ::= {

...

}

In some embodiments, the value representative of the realized throughput of the non-GBR bearers may be included in a handover request message along with a separate E-RAB Level QoS Parameters information element. Table 5 provides an example handover request message format in which an information element “non-GBR QoS Information” is included along with a separate E-RAB Level QoS Parameters information element. As discussed above with reference to Table 2, a different non-GBR QoS Information information element may be included in the handover request message for each non-GBR bearer of the UE 120 (and no such information element may be included in the handover request message for GBR bearers of the UE 120, as indicated in the semantics description).

TABLE 5
Example handover request message format.

| | | | | Semantics | | Assigned |
|---|---|---|---|---|---|---|
| IE/Group Name | Presence | Range | IE type and reference | description | Criticality | Criticality |
| Message Type | M | | 9.2.13 | | YES | reject |
| Old eNB UE X2AP | M | | eNB UE X2AP ID | Allocated at the | YES | reject |
| ID | | | 9.2.24 | source eNB | | |
| Cause | M | | 9.2.6 | | YES | ignore |
| Target Cell ID | M | | ECGI | | YES | reject |
| | | | 9.2.14 | | | |
| GUMMEI | M | | 9.2.16 | | YES | reject |
| UE Context | | 1 | | | YES | reject |
| Information | | | | | | |
| >MME UE S1AP | M | | INTEGER (0 . . . 2³² − 1) | MME UE S1AP ID | — | — |
| ID | | | | allocated at the | | |
| | | | | MME | | |
| >UE Security | M | | 9.2.29 | | — | — |
| Capabilities | | | | | | |
| >AS Security | M | | 9.2.30 | | — | — |
| Information | | | | | | |
| >UE Aggregate | M | | 9.2.12 | | — | — |
| Maximum Bit | | | | | | |
| Rate | | | | | | |
| >Subscriber | O | | 9.2.25 | | — | — |
| Profile ID for | | | | | | |
| RAT/Frequency | | | | | | |
| priority | | | | | | |
| >E-RABs To Be | | 1 | | | — | — |
| Setup List | | | | | | |
| >>E-RABs To | | 1 . . . | | | EACH | ignore |
| Be Setup | | <maxnoof | | | | |
| Item | | Bearers> | | | | |
| >>>E-RAB | M | | 9.2.23 | | — | — |
| ID | | | | | | |
| >>>E-RAB | M | | 9.2.9 | Includes | — | — |
| Level QoS | | | | necessary QoS | | |
| Parameters | | | | parameters | | |
| >>>DL | O | | 9.2.5 | | — | — |
| Forwarding | | | | | | |
| >>>UL GTP | M | | GTP Tunnel | SGW endpoint of | — | — |
| Tunnel | | | Endpoint 9.2.1 | the S1 transport | | |
| Endpoint | | | | bearer. For | | |
| | | | | delivery of UL | | |
| | | | | PDUs. | | |
| >>>non- | O | | | This IE applies to | | |
| GBR QoS | | | | non-GBR bearers | | |
| Information | | | | only and shall be | | |
| | | | | ignored | | |
| | | | | otherwise. | | |
| >RRC Context | M | | OCTET STRING | Includes the RRC | — | — |
| | | | | Handover | | |
| | | | | Preparation | | |
| | | | | Information | | |
| | | | | message as | | |
| | | | | defined in | | |
| | | | | subclause 10.2.2 | | |
| | | | | of TS 36.331 [9] | | |
| >Handover | O | | 9.2.3 | | — | — |
| Restriction List | | | | | | |
| >Location | O | | 9.2.21 | Includes the | — | — |
| Reporting | | | | necessary | | |
| Information | | | | parameters for | | |
| | | | | location | | |
| | | | | reporting | | |
| >Management | O | | 9.2.59 | | YES | ignore |
| Based MDT | | | | | | |
| Allowed | | | | | | |
| >Management | O | | MDT PLMN List | | YES | ignore |
| Based MDT | | | 9.2.64 | | | |
| PLMN List | | | | | | |
| UE History | M | | 9.2.38 | Same definition | YES | ignore |
| Information | | | | as in TS 36.413 | | |
| | | | | [4] | | |
| Trace Activation | O | | 9.2.2 | | YES | ignore |
| SRVCC Operation | O | | 9.2.33 | | YES | ignore |
| Possible | | | | | | |
| CSG Membership | O | | 9.2.52 | | YES | reject |
| Status | | | | | | |
| Mobility | O | | BIT STRING (SIZE (32)) | Information | YES | ignore |
| Information | | | | related to the | | |
| | | | | handover; the | | |
| | | | | source eNB | | |
| | | | | provides it in | | |
| | | | | order to enable | | |
| | | | | later analysis of | | |
| | | | | the conditions | | |
| | | | | that led to a | | |
| | | | | wrong HO. | | |

As noted above, in some embodiments in which the UE 120 includes multiple non-GBR bearers, the value representative of the realized throughput (provided by the source AN 102 to the target AN 104) includes fewer values than the total number of non-GBR bearers. For example, the value representative of the realized throughput may include a single value representative of realized throughputs of multiple non-GBR bearers. Thus, in some embodiments, different QoS information corresponding to different ones of multiple non-GBR bearers of the UE 120 may not be provided to the target AN 104; instead, an aggregated or combined value may be provided to the target AN 104, representative of the realized throughput of multiple non-GBR bearers.

Table 6 provides an example handover request message format in which an information element “non-GBR QoS Information” is included apart from an “E-RABs To Be Setup Item” group of information elements. As discussed above, the E-RABs To Be Setup Item may specify the E-RABs of the UE 120, and may include an E-RAB Level QoS Parameters information element to specify QoS requirements for each of the GBR bearers of the UE 120. The E-RAB Level QoS Parameters information element, in this embodiment, may not include information about realized throughput or other QoS information for non-GBR bearers. A separate information element, “non-GBR QoS Information,” may provide one or more values representative of non-GBR realized throughput, aggregated or otherwise combined across multiple non-GBR bearers.

TABLE 6
Example handover request message format.

| | | | | Semantics | | Assigned |
|---|---|---|---|---|---|---|
| IE/Group Name | Presence | Range | IE type and reference | description | Criticality | Criticality |
| Message Type | M | | 9.2.13 | | YES | reject |
| Old eNB UE X2AP | M | | eNB UE X2AP ID | Allocated at the | YES | reject |
| ID | | | 9.2.24 | source eNB | | |
| Cause | M | | 9.2.6 | | YES | ignore |
| Target Cell ID | M | | ECGI | | YES | reject |
| | | | 9.2.14 | | | |
| GUMMEI | M | | 9.2.16 | | YES | reject |
| UE Context | | 1 | | | YES | reject |
| Information | | | | | | |
| >MME UE S1AP | M | | INTEGER (0 . . . 2³² − 1) | MME UE S1AP ID | — | — |
| ID | | | | allocated at the | | |
| | | | | MME | | |
| >UE Security | M | | 9.2.29 | | — | — |
| Capabilities | | | | | | |
| >AS Security | M | | 9.2.30 | | — | — |
| Information | | | | | | |
| >UE Aggregate | M | | 9.2.12 | | — | — |
| Maximum Bit | | | | | | |
| Rate | | | | | | |
| >Subscriber | O | | 9.2.25 | | — | — |
| Profile ID for | | | | | | |
| RAT/Frequency | | | | | | |
| priority | | | | | | |
| >E-RABs To Be | | 1 | | | — | — |
| Setup List | | | | | | |
| >>E-RABs To | | 1 . . . | | | EACH | ignore |
| Be Setup | | <maxnoof | | | | |
| Item | | Bearers> | | | | |
| >>>E-RAB | M | | 9.2.23 | | — | — |
| ID | | | | | | |
| >>>E-RAB | M | | 9.2.9 | Includes | — | — |
| Level QoS | | | | necessary QoS | | |
| Parameters | | | | parameters | | |
| >>>DL | O | | 9.2.5 | | — | — |
| Forwarding | | | | | | |
| >>>UL GTP | M | | GTP Tunnel | SGW endpoint of | — | — |
| Tunnel | | | Endpoint 9.2.1 | the S1 transport | | |
| Endpoint | | | | bearer. For | | |
| | | | | delivery of UL | | |
| | | | | PDUs. | | |
| >RRC Context | M | | OCTET STRING | Includes the RRC | — | — |
| | | | | Handover | | |
| | | | | Preparation | | |
| | | | | Information | | |
| | | | | message as | | |
| | | | | defined in | | |
| | | | | subclause 10.2.2 | | |
| | | | | of TS 36.331 [9] | | |
| >Handover | O | | 9.2.3 | | — | — |
| Restriction List | | | | | | |
| >Location | O | | 9.2.21 | Includes the | — | — |
| Reporting | | | | necessary | | |
| Information | | | | parameters for | | |
| | | | | location | | |
| | | | | reporting | | |
| >Management | O | | 9.2.59 | | YES | ignore |
| Based MDT | | | | | | |
| Allowed | | | | | | |
| >Management | O | | MDT PLMN List | | YES | ignore |
| Based MDT | | | 9.2.64 | | | |
| PLMN List | | | | | | |
| UE History | M | | 9.2.38 | Same definition | YES | ignore |
| Information | | | | as in TS 36.413 | | |
| | | | | [4] | | |
| Trace Activation | O | | 9.2.2 | | YES | ignore |
| SRVCC Operation | O | | 9.2.33 | | YES | ignore |
| Possible | | | | | | |
| CSG Membership | O | | 9.2.52 | | YES | reject |
| Status | | | | | | |
| Mobility | O | | BIT STRING (SIZE (32)) | Information | YES | ignore |
| Information | | | | related to the | | |
| | | | | handover; the | | |
| | | | | source eNB | | |
| | | | | provides it in | | |
| | | | | order to enable | | |
| | | | | later analysis of | | |
| | | | | the conditions | | |
| | | | | that led to a | | |
| | | | | wrong HO. | | |
| non-GBR QoS | O | | | This IE applies to | | |
| Information | | | | non-GBR bearers | | |
| | | | | only and shall be | | |
| | | | | ignored | | |
| | | | | otherwise. | | |

Table 7 provides an illustrative non-GBR QoS Information information element, such as may be used with the handover request message of Table 6. The non-GBR QoS Information information element of Table 7 may include separate values for average downlink throughput and average uplink throughput, each averaged over a time window and also averaged over multiple non-GBR bearers. As noted above with reference to Table 3, the particular throughput values of Table 7 are simply illustrative, and any value representative of realized throughput or other realized or desired performance characteristics of non-GBR bearer services may be used. The illustrative structure of Table for may be used for the for the non-GBR QoS Information information element of Table 7.

TABLE 7
Example non-GBR QoS Information Information element.

| | | | IE type and | Semantics |
|---|---|---|---|---|
| IE/Group Name | Presence | Range | reference | description |
| E-RAB Average | M | | Bit Rate | Desc.: This IE |
| Throughput | | | 9.2.1.19 | indicates the |
| Downlink | | | | average downlink |
| | | | | E-RAB Bit Rate |
| | | | | for all non-GBR |
| | | | | bearers. |
| E-RAB Average | M | | Bit Rate | Desc.: This IE |
| Throughput | | | 9.2.1.19 | indicates the |
| Uplink | | | | average uplink |
| | | | | E-RAB Bit for |
| | | | | all non-GBR |
| | | | | bearers. |

In some embodiments, when the UE 120 has one or more GBR bearers, the handover request information provided by the handover source logic 214 may include QoS requirements for the GBR bearers. Examples of QoS requirements for the GBR bearers may include packet delay, packet error rate, and guaranteed bit rate (some or all of which may be included in a a QoS class identifier (QCI)).

In some embodiments, the handover request information provided by the handover source logic 214 may include information related to non-GBR bearers, but that is not representative of realized throughput or other realized or desired performance characteristics of non-GBR bearer services. For example, the handover request information provided by the handover source logic 214 may include a UE aggregate maximum bit rate (UE-AMBR) for the UE 120. The UE-AMBR may specify the maximum bit rate allowed for the UE 120 for all of its non-GBR services.

Referring now to FIG. 3, example components of the target AN 104 are illustrated. The components of the target AN 104, discussed in detail below, may be included in any one or more ANs included in a wireless communication network (e.g., the AN 102 of the wireless communication environment 100). In particular, an AN may include the components illustrated in both FIG. 2 and FIG. 3, and thus may act as both a source AN (for handing over UEs) and as a target AN (for receiving handed over UEs). In some embodiments, the target AN 104 may be an eNB, or included in an eNB.

The target AN 104 may include receiver/transmitter logic 306. The receiver/transmitter logic 306 may be coupled with an antenna 302 and/or a wired communication interface 304, and may be configured to receive and/or transmit wired and/or wireless signals to other devices, such as any of the devices discussed above with reference to FIG. 1. The receiver/transmitter logic 306 may take the form of any of the embodiments discussed above with reference to the receiver/transmitter logic 206, and thus will not be discussed further.

The target AN 104 may include handover target logic 308. The handover target logic 308 may be coupled with the receiver/transmitter logic 306, and may be configured to receive handover request information for a UE from a source AN serving the UE. For ease of illustration the handover target logic 308 may be discussed herein as receiving handover request information for the UE 120 from the source AN 102. The handover target logic 308 may receive the handover request information by storing some or all of the handover request information in a memory 312. The memory 312 may take the form of any of the memory devices described herein, and may store any suitable information used in handover operations by the AN 104.

In some embodiments, the handover request information received by the handover target logic 308 may include a value representative of a realized throughput of at least one non-GBR bearer of the UE 120. This value may take the form of any of the values discussed above with reference to the handover source logic 214 of FIG. 2. For example, the value may include multiple values representative of realized throughputs of corresponding multiple non-GBR bearers. The form in which the handover request information is received by the handover target logic 308 may take any of the forms described above with reference to the handover source logic 214 of FIG. 2. For example, the value representative of the realized throughput of the non-GBR bearers may be included in a handover request message (e.g., in an E-RAB Level QoS Parameters information element or along with an E-RAB Level QoS Parameters information element). The pathway through which the handover request information may be received by the target AN 104 may include any of the pathways discussed herein, such as the communication link 114 and/or the backhaul link 108. For example, in some embodiments, the handover request information may be received from the source AN 102 via an MME included in the backbone network 106.

The target AN 104 may include resource logic 310. The resource logic 310 may be coupled with the handover target logic 308, and may be configured to determine whether the target AN 104 has resources sufficient to take over service of a UE based at least in part on the value representative of the realized throughput of the at least one non-GBR bearer of the UE. For ease of illustration, the resource logic 310 may be discussed herein as receiving handover request information, including the value representative of the realized throughput of the at least one non-GBR bearer, for the UE 120 from the source AN 102.

The resource logic 310 may be configured to determine whether the target AN 104 has sufficient resources to take over service of the UE 120 in any of a number of ways. For example, in some embodiments, the target AN 104 may estimate the throughput that the UE 120 is expected to receive in the target cell 118. This estimation may be based on the resources available in the target cell 118 (i.e., not consumed by other UEs) and the estimated modulation coding scheme (MCS) of the UE 120. The target AN 104 may estimate the MCS based on measurements provided by the UE 120 (which may be included in a handover request message). The target AN 104 may than compared the estimated throughput the UE 120 is expected to receive in the target cell 118 to a desired or target value indicated by the source AN 102 in the handover request information (including, e.g., the value representative of the realized throughput of the at least one non-GBR bearer of the UE 120). The estimated throughput is significantly lower than the throughput the UE 120 received in the source cell 116 (as indicated, e.g., by the value representative of the realized throughput of the at least one non-GBR bearer of the UE 120), the target AN 104 may reject the handover of the UE 120.

The resource logic 310 may be configured to determine whether or not to take over service of the UE 120 based on the determination as to whether the target AN 104 has resources sufficient to take over service of the UE 120. In some embodiments, the resource logic 310 may determine to accept a handover request (and take over service of the UE 120) but not to admit all of the bearers of the UE 120. Whether and how to take over service of the UE 120 may be based at least in part on the “cause” for the handover request, as indicated by the source AN 102. For example, if the cause of the handover request is for energy saving, the resource logic 310 may be configured to determine whether the target cell 118 has resources sufficient to admit all of the bearers of the UE 120; if insufficient resources are available to admit all of the bearers, the resource logic 310 may determine to reject the handover request. This may be suitable because the source AN 102 may still be able to handle service of the UE 120 (but would prefer to handover service in order to save energy), and thus the handover is not “required” for service of the UE 120 to continue. However, if the cause of the handover request is critically poor radio conditions (e.g., when the UE 120 has moved out of the service range of the cell 116), the resource logic 310 may determine to accept a handover request and admit some of the bearers of the UE 120, even if all of the bearers of the UE 120 may not be admitted. This may be suitable because the source AN 102 may not be able to continue to handle service of the UE 120, and thus a handover accompanied by a decrease in performance may be preferable to a more substantial or complete failure of performance.

In some embodiments, if the cause for the handover request is energy saving, the resource logic 310 may be configured with a threshold number, amount, and/or type of bearers of the UE 120 that must be admissible before the handover request may be accepted and service of the UE 120 may be assumed. Adjusting this threshold may allow an operator to trade-off network energy savings versus quality of user experience. The resource logic 310 may be configured to apply different thresholds for handover requests with different causes.

In some embodiments, if the resource logic 310 determines to accept service of the UE 120, the target AN 104 may transmit an acknowledge message to the source AN 102, specifying which bearers have been admitted and/or which bearers have not. Admittance by the target AN 104 of a bearer may result in the target AN 104 reserving some resources as required and/or expected for the admitted bearers. The source AN 102 may indicate to the UE 120 that a handover is to take place, and may provide the UE 120 with necessary handover-related information. During a handover, data may be forwarded from the source AN 102 to the target AN 104.

In some embodiments, the exchange of data related to handover between the source AN 102 and the target AN 104 may take place over a wired X2 interface. In some embodiments, the exchange of data related to handover between the source AN 102 and the target AN 104 may take place over an S1 interface. Because communication via an X2 interface may be faster than communication via an S1 interface, the use of an X2 interface may be preferable and in some embodiments, an S1 interface may only be used where an X2 interface is not deployed. Handovers conducted via an X2 or an S1 interface may benefit from the systems and techniques disclosed herein. Handover may be performed and completed in accordance with known techniques, and thus is not discussed further.

The systems and techniques disclosed herein may advantageously enable network energy saving in wireless communication environments while maintaining the quality of the end user's experience. In particular, the systems and techniques disclosed herein may allow ANs and other network equipment to go into reduced power modes without compromising or interrupting a user's enjoyment of non-GBR services. One context in which the systems and techniques disclosed herein may be especially beneficial is the context of a smaller cell maintained within or overlapping with a larger cell. During times of heavy use, the smaller cell and the larger cell may both be operational to serve various UEs. However, when the load on the wireless communication environment decreases (e.g., at night, as may be measured by the number of UEs served or semi-statically pre-provisioned via operation and management (OAM)), significant energy savings may be achieved by powering down the AN serving the smaller cell and handing over any UEs to the larger cell. During handover, QoS requirements for GBR bearers may be communicated to the larger cell and may be maintained upon handover. Indeed, in conventional approaches, the only information provided to the target AN related to non-GBR bearers may be the UE-AMBR, which may provide a “cap” on QoS for non-GBR services, but not a “floor.”

Because no QoS requirements have typically been associated with a non-GBR bearer, the resources given to the non-GBR bearer by the larger cell may be substantially less than those devoted to the non-GBR bearer by the smaller cell. This may result in a serious degradation in the quality of a user's experience (e.g., when the downlink or uplink bit rate in the larger cell is less than the bit rate in the smaller cell). For example, many video streaming applications may run on non-GBR bearers; if a smaller cell supporting such an application is powered down to conserve energy, the application may not be able to continue running uninterrupted upon handover. Many of the most commonly used applications (e.g., web browsing, video streaming, chat and email) may use non-GBR bearers; consequently, the systems and techniques disclosed herein for improving user experience in non-GBR services address a significant but previously unrecognized issue. Improving a user's quality of experience during energy-saving handovers may enable more aggressive energy-saving policies to be implemented, without negatively affecting the user. This may be especially advantageous for network components that must operate for long periods of time on stored power, and may enable extended lifetimes for these components. The systems and techniques disclosed herein may also be advantageous during non-energy-saving handovers, and thus may generally improve the user's quality of experience.

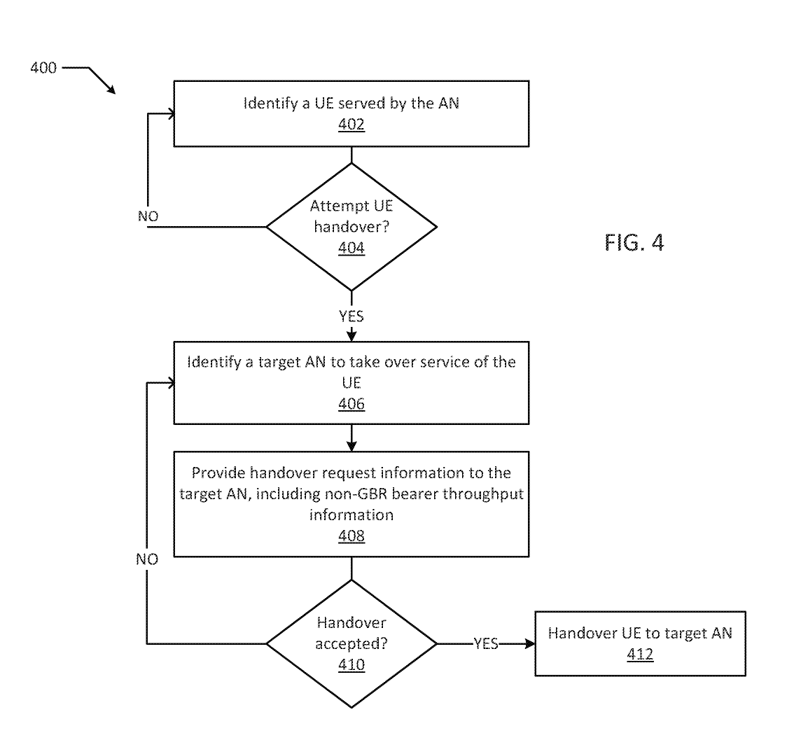

FIG. 4 is a flow diagram of a process 400 for handing over a UE from a source AN to a target AN. For ease of illustration, the process 400 may be discussed below with reference to the UE 120 being handed over from the source AN 102 to the target AN 104. It may be recognized that, while the operations of the process 400 (and the other processes described herein) are arranged in a particular order and illustrated once each, in various embodiments, one or more of the operations may be repeated, omitted or performed out of order. For illustrative purposes, operations of the process 400 may be described as performed by the source AN 102, but the process 400 may be performed by any suitably configured device (e.g., a programmed processing system, an ASIC, or another wireless computing device).

At the operation 402, the source AN 102 (e.g., the UE logic 210 of FIG. 2) may identify the UE 120 served by the source AN 102. The UE 120 may include at least one non-GBR bearer. In some embodiments, the operation 402 may include storing or accessing a record for the UE 120 in the memory 220, which may include a list of the bearers associated with the UE 120 (e.g., the GBR and/or non-GBR bearers).

At the operation 404, the source AN 102 (e.g., the target AN logic 212) may determine whether or not to attempt to handover of the UE 120. In some embodiments, the source AN 102 may perform the operation 404 by evaluating the current and/or predicted load on the source AN 102, and determining whether this load falls below a threshold for transitioning into an energy saving state. If the source AN 102 determines at the operation 404 that no attempt to handover the UE 120 is to be made, the source AN 102 may return to the operation 402. Returns to the operation 402 may occur in accordance with a predetermined schedule and/or in response to an event (e.g., an instruction from the backbone network 106 to evaluate whether or not handover may result in energy savings).

If the source AN 102 determines at the operation 404 than an attempt to handover the UE 120 is to be made, the source AN 102 may proceed to the operation 406 and identify a target AN to take over service of the UE 120. In some embodiments, the operation 404 may include storing or accessing a record for potential target ANs in the memory 220. For purposes of discussion, the target AN identified at the operation 406 will be referred to as the target AN 104. In some embodiments, a record associated with the target AN 104 in the memory 220 may include an identifier of the target AN and may include one or more measurements related to the cell 118 associated with the target AN 104 (such as any of the measurements made by the UE 120, discussed above).

In some embodiments, the operation 406 may include selecting a particular target AN from a set of candidate target ANs. Information about the candidate target ANs may be stored in records in the memory 220, and may be evaluated by the AN 102 to identify an appropriate or optimal potential target AN. The source AN 102 may select the target AN 104 to take over service of the UE 120.

At the operation 408, the source AN 102 (e.g., the handover source logic 214) may provide handover request information to the target AN 104 (identified at the operation 406). The handover request information provided at the operation 408 may include a value representative of a realized throughput of at least one non-GBR bearer of the UE 120. In some embodiments, the handover source logic 214 may provide the handover request information at the operation 408 by providing the handover request information to the receiver/transmitter logic 206 for transmission to the target AN 104, or by providing the handover request information to another component for processing prior to transmission by the receiver/transmitter logic 206. The value representative of the realized throughput of at least one non-GBR bearer of the UE 120 may take the form of any of the values discussed above with reference to the handover source logic 214 of FIG. 2. For example, the value may include multiple values representative of realized throughputs of corresponding multiple non-GBR bearers, a single value representative of the realized throughputs of multiple non-GBR bearers, separate uplink and downlink throughput values, etc.

At the operation 410, the source AN 102 (e.g., the handover source logic 214) may determine whether or not the handover request has been accepted by the target AN 104. In some embodiments, this determination may be based on acknowledgment messages transmitted from the target AN 104 to the source AN 102 in response to a handover request message or other message. If the source AN 102 determines at the operation 410 of the handover request has not been accepted, the source AN 102 may return to the operation 406 and may identify another target AN to take over service of the UE 120. In some embodiments, the target AN identified at the operation 406 after a handover failure at the operation 410 may be different target AN than the one previously targeted, or may be a same AN.

If the source AN 102 determines at the operation 410 of the handover request has been accepted by the target AN 104, the source AN 102 may proceed to the operation 412 and handover the UE 120 the target AN 104. As noted above, handover may be performed in accordance with any suitable known procedure. In some embodiments, upon handing over all UEs served by the source AN 102, the source AN 102 may enter an energy saving mode.

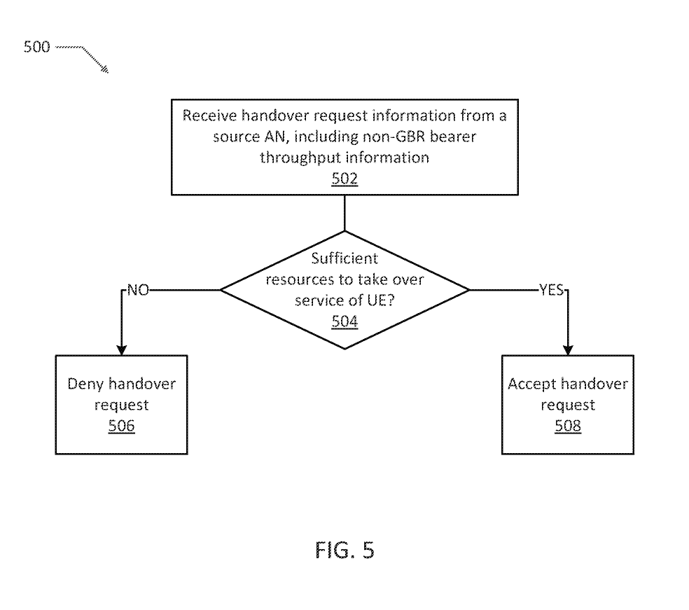

FIG. 5 is a flow diagram of a process 500 for taking over service of a UE by a target AN from a source AN. For ease of illustration, the process 500 may be discussed below with reference to the UE 120 being handed over from the source AN 102 to the target AN 104, and may be described as performed by the target AN 104 (but the process 500 may be performed by any suitably configured device (e.g., a programmed processing system, an ASIC, or another wireless computing device)).

At the operation 502, the target AN 104 (e.g., the handover target logic 308) may receive handover request information from the source AN 102. The handover request information received at the operation 502 may include a value representative of a realized throughput of at least one non-GBR bearer of the UE 120. This value may take the form of any of the values discussed above with reference to the handover source logic 214 of FIG. 2. In some embodiments, receiving handover request information from the source AN 102 may include receiving information at the receiver/transmitter logic 306 and storing some or all of that information in the memory 312. The form in which the handover request information is received by the handover target logic 308 may take any of the forms described above with reference to the handover source logic 214 of FIG. 2 and the handover target logic 308. The pathway through which the handover request information may be received by the target AN 104 may include any of the pathways discussed herein, such as the communication link 114 and/or the backhaul link 108.

At the operation 504, the target AN 104 (e.g., the resource logic 310) may determine whether or not the target AN 104 has sufficient resources to take over service of the UE 120 from the source AN 102. This determination may take the form of any of the embodiments described above with reference to the resource logic 310, and may be based at least in part on the value representative of the realized throughput of the at least one non-GBR bearer of the UE 120 (received at the operation 502).

If the target AN 104 determines at the operation 504 that insufficient resources are available, the target AN 104 may deny the handover request at the operation 506. If the target AN 104 determines at the operation 504 that sufficient resources are available to take over service of the UE 120, the target AN 104 may accept a handover request at the operation 508. Handover may then proceed in accordance with any suitable known procedure.

FIG. 6 is a block diagram of an example computing device 600, which may be suitable for practicing various disclosed embodiments. For example, the computing device 600 may serve as the UE 120, the source AN 102, the target AN 104 or any other suitable device discussed herein. The computing device 600 may include a number of components, including one or more processor(s) 604 and at least one communication chip 606. In various embodiments, the processor 604 may include a processor core. In various embodiments, at least one communication chip 606 may also be physically and electrically coupled to the processor 604. In further implementations, the communication chip 606 may be part of the processor 604. In various embodiments, the computing device 600 may include a PCB 602. For these embodiments, the processor 604 and the communication chip 606 may be disposed thereon. In alternate embodiments, the various components may be coupled without the employment of the PCB 602.

Depending on its applications (e.g., various applications using GBR or non-GBR bearers), the computing device 600 may include other components that may or may not be physically and electrically coupled to the PCB 602. These other components include, but are not limited to, volatile memory (e.g., dynamic random access memory (DRAM) 608), non-volatile memory (e.g., read-only memory (ROM) 610, one or more hard disk drives, one or more solid-state drives, one or more compact disc drives, and/or one or more digital versatile disc drives), flash memory 612, input/output controller 614, a digital signal processor (not shown), a crypto processor (not shown), graphics processor 616, one or more antenna 618, touch screen display 620, touch screen controller 622, other displays (such as liquid-crystal displays, cathode-ray tube displays and e-ink displays, not shown), battery 624, an audio codec (not shown), a video codec (not shown), global positioning system (GPS) device 628, compass 630, an accelerometer (not shown), a gyroscope (not shown), speaker 632, camera 634, and a mass storage device (such as hard disk drive, a solid state drive, compact disk (CD), digital versatile disk (DVD)) (not shown), any other desired sensors (not shown) and so forth. In various embodiments, the processor 604 may be integrated on the same die with other components to form a System on Chip (SoC). Any components included in the computing device 600 (e.g., sensors) may be used in various services using GBR and/or non-GBR bearers, and/or in operations related to handover of the UE having GBR and/or non-GBR bearers (e.g., by inclusion in the source AN 102, the target AN 104, and/or the UE 120).

In various embodiments, volatile memory (e.g., DRAM 608), non-volatile memory (e.g., ROM 610), flash memory 612, and the mass storage device may include programming instructions configured to enable the computing device 600, in response to execution by the processor(s) 604, to practice all or selected aspects of the processes described herein (e.g., the handover request and handover acceptance processes). For example, one or more of the memory components such as volatile memory (e.g., DRAM 608), non-volatile memory (e.g., ROM 610), flash memory 612, and the mass storage device may be machine readable media that include temporal and/or persistent (e.g., non-transitory) copies of instructions that, when executed by the one or more processor(s) 604, enable the computing device 600 to practice all or selected aspects of the processes described herein. Memory accessible to the computing device 600 may include one or more storage resources that are physically part of a device on which the computing device 600 is installed and/or one or more storage resources that is accessible by, but not necessarily a part of, the computing device 600. For example, a storage resource may be accessed by the computing device 600 over a network via the communications chip 606. Any one or more of these memory devices may be included in the memory 220 of the source AN 102 or the memory 312 of the target AN 104.

The communication chip 606 may enable wired and/or wireless communications for the transfer of data to and from the computing device 600. The term “wireless” and its derivatives may be used to describe circuits, devices, systems, methods, techniques, communication channels, etc., that may communicate data through the use of modulated electromagnetic radiation through a non-solid medium. The term does not imply that the associated devices do not contain any wires, although in some embodiments they might not. Many of the embodiments described herein may be used with WiFi and 3GPP/LTE communication systems, as noted above. However, communication chips 606 may implement any of a number of wireless standards or protocols, including but not limited to any of the RATs described herein. The computing device 600 may include a plurality of communication chips 606. For instance, a first communication chip 606 may be dedicated to shorter range wireless communications such as Wi-Fi and Bluetooth and a second communication chip 606 may be dedicated to longer range wireless communications such as GPS, EDGE, GPRS, CDMA, WiMAX, LTE, Ev-DO, and others.

As discussed above with reference to the source AN 102, the target AN 104 and the UE 120, in various implementations, the computing device 600 may be a laptop, a netbook, a notebook, an ultrabook, a smartphone, a computing tablet, a personal digital assistant, an ultra mobile PC, a mobile phone, a desktop computer, a server, a printer, a scanner, a monitor, a set-top box, an entertainment control unit (e.g., a gaming console), a digital camera, a portable music player, or a digital video recorder. In further implementations, the computing device 600 may be any other electronic device that processes data.

The following paragraphs describe examples of various embodiments. Example 1 is an AN, including: UE logic to identify a UE served by the AN, the UE having at least one non-GBR bearer; target AN logic to identify a target AN to take over service of the UE from the AN; and handover source logic, coupled with the UE logic and the target AN logic, to provide handover request information to the target AN, the handover request information including a value representative of realized throughput of the at least one non-GBR bearer.

Example 2 may include the subject matter of Example 1, and may further specify that the UE has a plurality of non-GBR bearers and the value representative of realized throughput data of the at least one non-GBR bearer includes a plurality of values representative of realized throughputs of the corresponding plurality of non-GBR bearers.

Example 3 may include the subject matter of any of Examples 1-2 and may further specify that the UE has a plurality of non-GBR bearers and the value representative of realized throughput data of the at least one non-GBR bearer includes a value representative of realized throughputs of the plurality of non-GBR bearers.

Example 4 may include the subject matter of any of Examples 1-3, and may further specify that the value representative of realized throughput of the at least one non-GBR bearer includes a value representative of realized uplink throughput of the at least one non-GBR bearer and a value representative of realized downlink throughput of the at least one non-GBR bearer.

Example 5 may include the subject matter of any of Examples 1-4, and may further specify that the value representative of realized throughput of the at least one non-GBR bearer includes an average throughput over a time window.

Example 6 may include the subject matter of any of Examples 1-5, and may further specify that the value representative of realized throughput of the at least one non-GBR bearer includes a maximum throughput over a time window or a minimum throughput over a time window.

Example 7 may include the subject matter of any of Examples 1-6, and may further specify that the handover request information indicates that a handover request cause is energy saving.

Example 8 is an AN, including: handover target logic to receive handover request information for a UE from a source AN serving the UE, the handover request information including a value representative of realized throughput of at least one non-GBR bearer of the UE; and resource logic to determine whether the AN has resources sufficient to take over service of the UE based at least in part on the value.

Example 9 may include the subject matter of Example 8, and may further specify that the value is included in an E-RAB Level QoS Parameters information element.

Example 10 may include the subject matter of any of Examples 8-9, and may further specify that the value is included in a handover request message.

Example 11 may include the subject matter of any of Examples 8-10, and may further specify that the value is included in a handover request message along with an E-RAB Level QoS Parameters information element.

Example 12 may include the subject matter of any of Examples 8-11, and may further specify that the handover request information indicates that a handover request cause is energy saving, and wherein the resource logic is to determine whether the AN has resources sufficient to take over service of the UE based at least in part on the handover request cause.

Example 13 may include the subject matter of Example 12, and may further specify that the resource logic is to determine that the AN has resources sufficient to take over service of the UE if the AN has resources sufficient to admit a threshold amount, number, and/or type of bearers of the UE.

Example 14 may include the subject matter of any of Examples 8-13, and may further specify that the handover request information includes a UE-AMBR, in addition to the value.

Example 15 is one or more computer readable media including computer readable instructions which, when executed by an AN computing device, cause the AN computing device to: identify a UE served by the AN computing device, the UE having at least one non-guaranteed bit rate (non-GBR) bearer; provide handover request information to a target AN to take over service of the UE from the AN computing device, the handover request information including a value representative of realized throughput of the at least one non-GBR bearer; and receive an acknowledge message from the target AN, the acknowledge message transmitted in response to the target AN receiving the handover request information.

Example 16 may include the subject matter of Example 15, and may further specify that the UE has a plurality of non-GBR bearers and the value representative of realized throughput data of the at least one non-GBR bearer includes a plurality of values representative of realized throughputs of the corresponding plurality of non-GBR bearers.

Example 17 may include the subject matter of any of Examples 15-16, and may further specify that the UE has a plurality of non-GBR bearers and the value representative of realized throughput data of the at least one non-GBR bearer includes a value representative of realized throughputs of the plurality of non-GBR bearers.

Example 18 may include the subject matter of any of Examples 15-17, and may further specify that the value representative of realized throughput of the at least one non-GBR bearer includes a value representative of realized uplink throughput of the at least one non-GBR bearer and a value representative of realized downlink throughput of the at least one non-GBR bearer.

Example 19 may include the subject matter of any of Examples 15-18, and may further specify that the value representative of realized throughput of the at least one non-GBR bearer includes an average throughput over a time window.

Example 20 may include the subject matter of any of Examples 15-19, and may further specify that the value representative of realized throughput of the at least one non-GBR bearer includes a maximum throughput over a time window or a minimum throughput over a time window.

Example 21 may include the subject matter of any of Examples 15-20, and may further specify that the handover request information indicates that a handover request cause is energy saving.

Example 22 is one or more computer readable media including computer readable instructions which, when executed by an AN computing device, cause the AN computing device to: receive handover request information for a user equipment (UE) from a source AN serving the UE, the handover request information including a value representative of realized throughput of at least one non-GBR bearer of the UE; determine that the AN computing device has resources sufficient to take over service of the UE based at least in part on the value; and transmit an acknowledge message to the source AN in response to the determination that the AN computing device has resources sufficient to take over service of the UE.

Example 23 may include the subject matter of Example 22, and may further specify that the value is included in E-RAB Level QoS Parameters information element.

Example 24 may include the subject matter of any of Examples 22-23, and may further specify that the value is included in a handover request message along with a E-RAB Level QoS Parameters information element.

Example 25 may include the subject matter of any of Examples 22-23, and may further specify that: the handover request information indicates that a handover request cause is energy saving; and determine that the AN computing device has resources sufficient to take over service of the UE is based at least in part on the handover request cause.

Example 26 is a method, including: identifying a UE served by the AN, the UE having at least one non-GBR bearer; identifying a target AN to take over service of the UE from the AN; and providing handover request information to the target AN, the handover request information including a value representative of realized throughput of the at least one non-GBR bearer.

Example 27 may include the subject matter of Example 26, and may further specify that the UE has a plurality of non-GBR bearers and the value representative of realized throughput data of the at least one non-GBR bearer includes a plurality of values representative of realized throughputs of the corresponding plurality of non-GBR bearers.

Example 28 may include the subject matter of any of Examples 26-27 and may further specify that the UE has a plurality of non-GBR bearers and the value representative of realized throughput data of the at least one non-GBR bearer includes a value representative of realized throughputs of the plurality of non-GBR bearers.

Example 29 may include the subject matter of any of Examples 26-28, and may further specify that the value representative of realized throughput of the at least one non-GBR bearer includes a value representative of realized uplink throughput of the at least one non-GBR bearer and a value representative of realized downlink throughput of the at least one non-GBR bearer.

Example 30 may include the subject matter of any of Examples 26-29, and may further specify that the value representative of realized throughput of the at least one non-GBR bearer includes an average throughput over a time window.

Example 31 may include the subject matter of any of Examples 26-30, and may further specify that the value representative of realized throughput of the at least one non-GBR bearer includes a maximum throughput over a time window or a minimum throughput over a time window.

Example 32 may include the subject matter of any of Examples 26-31, and may further specify that the handover request information indicates that a handover request cause is energy saving.

Example 33 is a method, including: receiving handover request information for a UE from a source AN serving the UE, the handover request information including a value representative of realized throughput of at least one non-GBR bearer of the UE; and determining whether the AN has resources sufficient to take over service of the UE based at least in part on the value.

Example 34 may include the subject matter of Example 33, and may further specify that the value is included in an E-RAB Level QoS Parameters information element.

Example 35 may include the subject matter of any of Examples 33-34, and may further specify that the value is included in a handover request message.

Example 36 may include the subject matter of any of Examples 33-35, and may further specify that the value is included in a handover request message along with an E-RAB Level QoS Parameters information element.

Example 37 may include the subject matter of any of Examples 33-36, and may further specify that the handover request information indicates that a handover request cause is energy saving, and determining whether the AN has resources sufficient to take over service of the UE is based at least in part on the handover request cause.

Example 38 may include the subject matter of Example 37, and may further specify that determining that the AN has resources sufficient to take over service of the UE includes determining that the AN has resources sufficient to admit a threshold amount, number, and/or type of bearers of the UE.

Example 39 may include the subject matter of any of Examples 33-38, and may further specify that the handover request information includes a UE-AMBR, in addition to the value.

Example 40 may include means for performing the method of any of Examples 26-39.

Example 41 may include one or more computer readable media which, when executed by a computing device, cause the computing device to perform the method of any of Examples 26-39.

What is claimed is:

1. An access node (AN), comprising:
user equipment (UE) logic to identify a UE served by the AN, the UE having at least one non-guaranteed bit rate (non-GBR) bearer;
target AN logic to identify a target AN to take over service of the UE from the AN; and
handover source logic, coupled with the UE logic and the target AN logic, to provide handover request information to the target AN, the handover request information comprising a value representative of realized throughput of the at least one non-GBR bearer.

2. The AN of claim 1, wherein the UE has a plurality of non-GBR bearers and the value representative of realized throughput data of the at least one non-GBR bearer comprises a plurality of values representative of realized throughputs of the corresponding plurality of non-GBR bearers.

3. The AN of claim 1, wherein the UE has a plurality of non-GBR bearers and the value representative of realized throughput data of the at least one non-GBR bearer comprises a value representative of realized throughputs of the plurality of non-GBR bearers.

4. The AN of claim 1, wherein the value representative of realized throughput of the at least one non-GBR bearer includes a value representative of realized uplink throughput of the at least one non-GBR bearer and a value representative of realized downlink throughput of the at least one non-GBR bearer.

5. The AN of claim 1, wherein the value representative of realized throughput of the at least one non-GBR bearer comprises an average throughput over a time window.

6. The AN of claim 1, wherein the value representative of realized throughput of the at least one non-GBR bearer comprises a maximum throughput over a time window or a minimum throughput over a time window.

7. The AN of claim 1, wherein the handover request information indicates that a handover request cause is energy saving.

8. An access node (AN), comprising:
handover target logic to receive handover request information for a user equipment (UE) from a source AN serving the UE, the handover request information comprising a value representative of realized throughput of at least one non-guaranteed bit rate (non-GBR) bearer of the UE; and
resource logic to determine whether the AN has resources sufficient to take over service of the UE based at least in part on the value.

9. The AN of claim 8, wherein the value is included in an Evolved Universal Terrestrial Radio Access Network Radio Access Bearer (E-RAB) Level Quality of Service (QoS) Parameters information element.

10. The AN of claim 8, wherein the value is included in a handover request message.

11. The AN of claim 8, wherein the value is included in a handover request message along with an Evolved Universal Terrestrial Radio Access Network Radio Access Bearer (E-RAB) Level Quality of Service (QoS) Parameters information element.

12. The AN of claim 8, wherein the handover request information indicates that a handover request cause is energy saving, and wherein the resource logic is to determine whether the AN has resources sufficient to take over service of the UE based at least in part on the handover request cause.

13. The AN of claim 12, wherein the resource logic is to determine that the AN has resources sufficient to take over service of the UE if the AN has resources sufficient to admit a threshold amount, number, and/or type of bearers of the UE.

14. The AN of claim 8, wherein the handover request information comprises a UE Aggregate Maximum Bit Rate (UE-AMBR), in addition to the value.

15. One or more computer readable media comprising computer readable instructions which, when executed by an access node (AN) computing device, cause the AN computing device to:
identify a UE served by the AN computing device, the UE having at least one non-guaranteed bit rate (non-GBR) bearer;
provide handover request information to a target AN to take over service of the UE from the AN computing device, the handover request information comprising a value representative of realized throughput of the at least one non-GBR bearer; and
receive an acknowledge message from the target AN, the acknowledge message transmitted in response to the target AN receiving the handover request information.

16. The one or more computer readable media of claim 15, wherein the UE has a plurality of non-GBR bearers and the value representative of realized throughput data of the at least one non-GBR bearer comprises a plurality of values representative of realized throughputs of the corresponding plurality of non-GBR bearers.

17. The one or more computer readable media of claim 15, wherein the UE has a plurality of non-GBR bearers and the value representative of realized throughput data of the at least one non-GBR bearer comprises a value representative of realized throughputs of the plurality of non-GBR bearers.

18. The one or more computer readable media of claim 15, wherein the value representative of realized throughput of the at least one non-GBR bearer includes a value representative of realized uplink throughput of the at least one non-GBR bearer and a value representative of realized downlink throughput of the at least one non-GBR bearer.

19. The one or more computer readable media of claim 15, wherein the value representative of realized throughput of the at least one non-GBR bearer comprises an average throughput over a time window.

20. The one or more computer readable media of claim 15, wherein the value representative of realized throughput of the at least one non-GBR bearer comprises a maximum throughput over a time window or a minimum throughput over a time window.

21. The one or more computer readable media of claim 15, wherein the handover request information indicates that a handover request cause is energy saving.

22. One or more computer readable media comprising computer readable instructions which, when executed by an access node (AN) computing device, cause the AN computing device to:
receive handover request information for a user equipment (UE) from a source AN serving the UE, the handover request information comprising a value representative of realized throughput of at least one non-guaranteed bit rate (non-GBR) bearer of the UE;
determine that the AN computing device has resources sufficient to take over service of the UE based at least in part on the value; and
transmit an acknowledge message to the source AN in response to the determination that the AN computing device has resources sufficient to take over service of the UE.

23. The one or more computer readable media of claim 22, wherein the value is included in an Evolved Universal Terrestrial Radio Access Network Radio Access Bearer (E-RAB) Level Quality of Service (QoS) Parameters information element.

24. The one or more computer readable media of claim 22, wherein the value is included in a handover request message along with a Evolved Universal Terrestrial Radio Access Network Radio Access Bearer (E-RAB) Level Quality of Service (QoS) Parameters information element.

25. The one or more computer readable media of claim 22, wherein:
the handover request information indicates that a handover request cause is energy saving; and
determine that the AN computing device has resources sufficient to take over service of the UE is based at least in part on the handover request cause.
